(19) United States
(12) Patent Application Publication
(10) Pub. No.: US 2009/0228132 A1
(43) Pub. Date: Sep. 10, 2009

(54) METHOD AND APPARATUS FOR CONTROLLING STRESSED LAYER GATE PROXIMITY

(76) Inventors: Kevin R. Lensing, Austin, TX (US); Alok Vaid, Wappingers Falls, NY (US); Rohit Pal, Fishkill, NY (US)

Correspondence Address: WILLIAMS, MORGAN & AMERSON, 10333 RICHMOND, SUITE 1100, HOUSTON, TX, 77042, US

(21) Appl. No.: 12/045,081

(22) Filed: Mar. 10, 2008

(51) Int. Cl. G06F 17/00

(52) U.S. Cl. 700/103

(57) ABSTRACT

A method includes receiving a performance distribution for a plurality of devices to be fabricated in a semiconductor process flow. A performance target for a particular device is specified based on the performance distribution. A stressed material is formed in a recess adjacent a gate electrode of a transistor in the particular device in accordance with at least one operating recipe. The recess is spaced from the gate electrode by a gate proximity distance. A target value for the gate proximity distance is determined based on the performance target. At least one parameter of the operating recipe is determined based on the target value for the gate proximity distance.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE DISCLOSURE

The disclosed subject matter relates generally to the field of semiconductor device manufacturing and, more particularly, to a method and apparatus for controlling stressed layer gate proximity.

There is a constant drive within the semiconductor industry to increase the quality, reliability and throughput of integrated circuit devices, e.g., microprocessors, memory devices, and the like. This drive is fueled by consumer demands for higher quality computers and electronic devices that operate more reliably. These demands have resulted in a continual improvement in the manufacture of semiconductor devices, e.g., transistors, as well as in the manufacture of integrated circuit devices incorporating such transistors. Additionally, reducing the defects in the manufacture of the components of a typical transistor also lowers the overall cost per transistor as well as the cost of integrated circuit devices incorporating such transistors.

During the fabrication of complex integrated circuits using CMOS technology, millions of transistors are formed on a substrate including a crystalline semiconductor layer. A transistor includes pn-junctions that are formed by an interface of highly doped drain and source regions with an inversely doped channel region disposed between the drain region and the source regions. The conductivity of the channel region, i.e., the drive current capability of the conductive channel, is controlled by a gate electrode formed in the vicinity of the channel region and separated therefrom by a thin insulating layer. A conductive channel is formed when an appropriate control voltage is applied to the gate electrode. The conductivity of the channel region depends on the dopant concentration, the mobility of the majority charge carriers, and—for a given extension of the channel region in the transistor width direction—on the distance between the source and drain regions, which is also referred to as channel length.

Hence, the overall conductivity of the channel region substantially determines an aspect of the performance of the MOS transistors. By reducing the channel length, and accordingly, the channel resistivity, an increase in the operating speed of the integrated circuits may be achieved.

The continuing shrinkage of the transistor dimensions raises issues that have the potential to offset some of the advantages gained by the reduced channel length. For example, highly sophisticated vertical and lateral dopant profiles may be required in the drain and source regions to provide low sheet and contact resistivity in combination with a desired channel controllability. Moreover, the gate dielectric material may also need to be adapted to the reduced channel length to maintain the required channel controllability. However, some mechanisms for obtaining a high channel controllability may also have a negative influence on the charge carrier mobility in the channel region of the transistor, thereby partially offsetting the advantages gained by the reduction of the channel length.

During manufacturing, target production levels are set for devices of various grades to attempt to match output with actual or predicted customer demand. In the past, the typical control variable used to manipulate device performance has been the critical dimensions (CD) or the channel length of the transistors. Typically, a reduced channel length contributes to an increased maximum speed rating of the device. Hence, based on anticipated demands, grade targets are essentially established by setting CD targets for various lots of wafers. If a high number of high performing devices is desired, the CD targets are set at aggressive levels. The use of aggressive CD set points results in higher grade devices, but usually at the expense of yield.

As described above, in advanced device technologies, such as the 65 nm or smaller technology node, further reductions in the channel length may result in process difficulties. Hence, attempting to match manufacturing targets based on channel length targets may not be effective. Matching production levels to customer demand is an important contributor to the profitability of a facility. For example, if a large number of high performing devices (i.e., more expensive devices) have been produced, but the current demand is for lower cost devices (i.e., slower), orders may not be able to be filled with the desired grade device. As a result, the manufacturer may be forced to sell devices of a higher grade at a lower price to fill the order. If the demand is for higher grade devices, and the supply of higher grade devices is diminished, the manufacturer may be unable to fill the order at all. Either situation results in lost profits for the manufacturer.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF THE DISCLOSURE

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that includes receiving a performance distribution for a plurality of devices to be fabricated in a semiconductor process flow. A performance target for a particular device is specified based on the performance distribution. A stressed material is formed in a recess adjacent a gate electrode of a transistor in the particular device in accordance with at least one operating recipe. The recess is spaced from the gate electrode by a gate proximity distance. A target value for the gate proximity distance is determined based on the performance target. At least one parameter of the operating recipe is determined based on the target value for the gate proximity distance.

Another aspect of the disclosed subject matter is seen in a system including a plurality of tools for fabricating a plurality of devices and a performance target monitor. The tools are operable to form a stressed material in a recess adjacent a gate electrode of a transistor in a particular device in accordance with at least one operating recipe. The recess is spaced from the gate electrode by a gate proximity distance. The performance target monitor is operable to receive a performance distribution for the devices to be fabricated in the tools, specify a performance target for a particular device based on the performance distribution, and determine a target value for the gate proximity distance based on the performance target. The tools are operable to fabricate the particular device based on the target value for the gate proximity distance.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified diagram of an illustrative processing line for processing wafers in accordance with one illustrative embodiment of the present subject matter;

FIGS. 2A and 2B are cross-section diagrams of an exemplary prior art device including recessed stressed layers to induce stress in the channel region; and

FIG. 3 is a simplified flow diagram of a method for controlling stressed layer gate proximity in accordance with another illustrative embodiment of the present subject matter.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

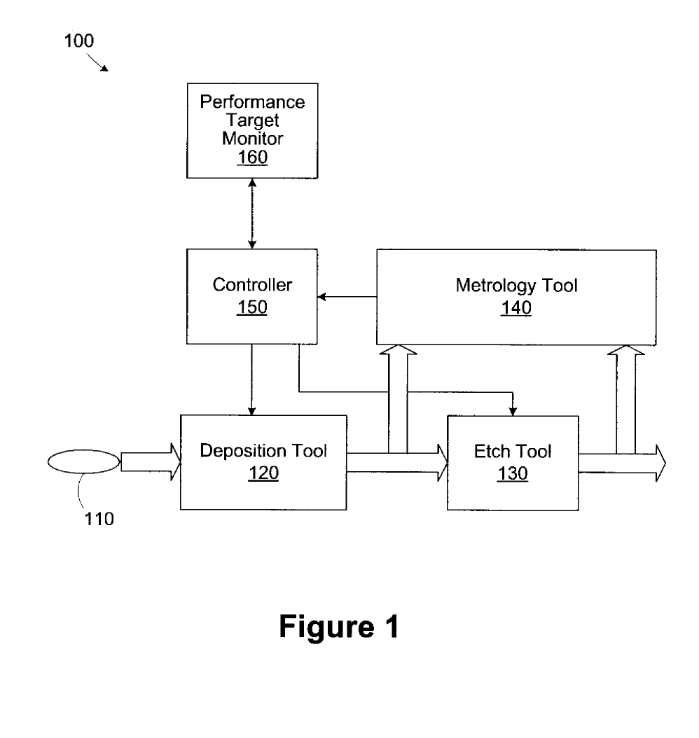

Referring now to the drawings wherein like reference numbers correspond to similar components throughout the several views and, specifically, referring to FIG. 1, the disclosed subject matter shall be described in the context of a processing line 100 for processing wafers 110 in accordance with one illustrative embodiment of the present subject matter is provided. In the illustrated embodiment, the processing line 100 includes a deposition tool 120 for forming one or more process layers on the wafer 110, an etch tool 130 for etching various features in the various process layers, a metrology tool 140, a controller 150, and a performance target monitor 160.

In the illustrated embodiment, the processing line 100 is configured to manufacture devices having advanced strain characteristics to influence device performance. In general, the performance target monitor 160 attempts to influence the strain characteristics of the completed devices to match the performance of fabricated devices to expected or actual customer demand to increase the efficiency and profitability of the processing line 100.

One efficient mechanism for increasing the charge carrier mobility is to modify the lattice structure in the channel region, for instance by creating tensile or compressive stress in the vicinity of the channel region so as to produce a corresponding strain in the channel region. This stress results in a modified mobility for electrons and holes, respectively. For example, creating tensile strain in the channel region for a standard crystallographic configuration of the active silicon material increases the mobility of electrons, which, in turn, may directly translate into a corresponding increase in the conductivity. On the other hand, compressive strain in the channel region may increase the mobility of holes, thereby providing the potential for enhancing the performance of p-type transistors.

One technique for inducing stress in the channel region involves introducing, for instance, a silicon/germanium layer next to the channel region so as to induce a compressive stress that may result in a corresponding strain. The transistor performance of p-channel transistors may be considerably enhanced by the introduction of stress-creating layers next to the channel region. For this purpose a strained silicon/germanium layer may be formed in the drain and source regions of the transistors. The compressively strained drain and source regions create uni-axial strain in the adjacent silicon channel region. When forming the Si/Ge layer, the drain and source regions of the PMOS transistors are selectively recessed, while the NMOS transistors are masked. Subsequently, the silicon/germanium layer is selectively formed by epitaxial growth. For generating a tensile strain in the silicon channel region, Si/C may be used instead of SiGe.

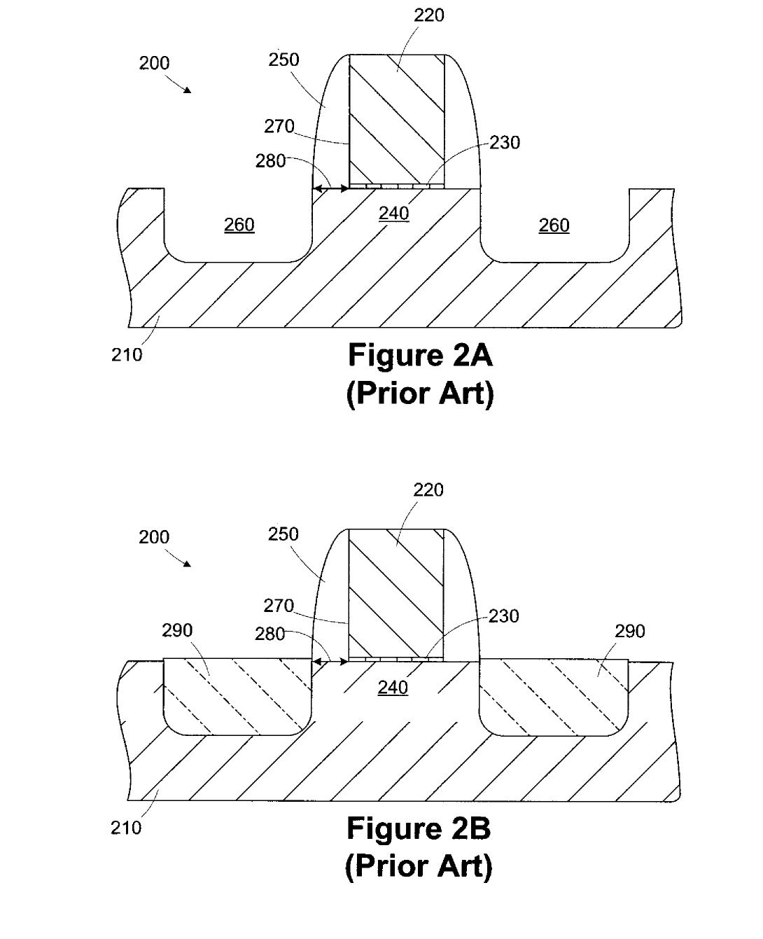

FIG. 2A shows a cross-sectional view of a semiconductor device 200 in an early manufacturing stage. The semiconductor device 200 comprises a semiconductor layer 210 of a first semiconductor material in and/or on which circuit elements, such as transistors, capacitors, resistors, and the like may be formed. The semiconductor layer 210 may be provided on a substrate (not shown), e.g. on a bulk semiconductor substrate or a semiconductor-on-insulator (SOI) substrate, wherein the semiconductor layer 210 may be formed on a buried insulation layer. The semiconductor layer 210 may be a silicon-based crystalline semiconductor layer comprising silicon with a concentration of at least 50%. The semiconductor layer 210 may represent a doped silicon layer as is typically used for highly complex integrated circuits having transistor elements with a gate length around 50 nm or below.

A gate electrode 220 may be formed above the semiconductor layer 210. The gate electrode 220 may be formed of doped polysilicon or other suitable material which is provided above the semiconductor layer 210 and is separated therefrom by a gate insulation layer 230. The first semiconductor material 210 forms a channel region 240 for a finished transistor. Sidewalls of the gate electrode 220 are provided with disposable sidewall spacers 250. The disposable sidewall spacers 250 may consist of any appropriate dielectric material, such a silicon nitride, silicon dioxide, or mixtures thereof. The disposable sidewall spacers 250 may be formed by depositing a conformal layer of dielectric material and etching the conformal layer using an anisotropic etch to define the spacers 250. The disposable sidewall spacers 250 may be used as an etch and growth mask in an etch process and subsequent epitaxial growth process for the formation of an embedded strained semiconductor region.

The semiconductor device 200 of FIG. 2A further comprises a recess 260 defined in the semiconductor layer 210. The recess 260 may be formed by performing a well established anisotropic etch process while using the sidewall spacers 250 as a mask. Therefore, the width of the disposable sidewall spacers 250 determines the lateral distance between the sidewalls 270 of the gate electrode 220 and the recess 260, referred to herein as the gate proximity distance 280.

It should be appreciated that after the formation of the recess 260, the semiconductor device 200 may be subjected to any necessary or suitable pretreatments for preparing the device 200 for a subsequent epitaxial growth process. Thereafter, a stressed semiconductor material 290 (see FIG. 2B) is grown in the recess 260. The stressed semiconductor material 290 comprises a first alloy component and a second alloy component. In an illustrative embodiment, the first alloy component is silicon and the second alloy component is germanium. The growth of the stressed semiconductor material 290 in the recess 260 may performed by using a selective epitaxial growth process using the material of the recess bottom and/or sidewalls as a template. In one illustrative embodiment, an appropriate deposition atmosphere may be established comprising of a silicon-containing precursor material and a germanium-containing precursor material. Typically in selective epitaxial growth processes, the process parameters, such as pressure, temperature, type of carrier gases and the like are selected such that substantially no material is deposited on dielectric surfaces such as the surfaces of the spacer 250 and a possible capping layer (not shown), while a deposition is obtained on exposed surfaces of the first semiconductor layer 210, thereby using this layer as a crystalline template, which substantially determines the crystalline structure of the epitaxially grown stressed semiconductor material 290. Since the covalent radius of germanium is larger than the covalent radius of the silicon, growing the silicon/germanium material on a silicon template results in a strained silicon/germanium layer which induces a compressive strain in the channel region 240. It should be appreciated that any appropriate stressed semiconductor material may be used, depending on the type of the first semiconductor material and the desired strain type in the first semiconductor material. For example in other embodiments, which use silicon or a silicon-based material as the first semiconductor material, the stressed semiconductor material may be silicon/carbon (SiC) for inducing a tensile strain in the channel region 240.

During the formation of stressed silicon structures, several parameters affect the net stress, which in turn modulates the hole or electron mobility. These parameters include the proximity of the strained material to the gate electrode (e.g., gate proximity distance 280), the recess depth, the stress dopant (e.g., germanium or carbon) content of the stressed film, implant conditions, etc.

Returning to FIG. 1, the deposition tool 120 may be used to form the process layers for the gate electrode 220, the gate insulation layer 230, the sidewall spacers 250, and/or the stressed semiconductor material 290. The etch tool 130 may be employed to form the gate electrode 220, the sidewall spacers 250, and or the recesses 260. For ease of illustration and to avoid obscuring the present subject matter, only a portion of the processing line 100 is illustrated. An actual implementation of the processing line 100 may have additional types of tools and multiples instances of each tool type. For example, different etch tools and/or deposition tools may be used to form the process layers or features described above.

In general, the metrology tool 140 determines the value of the gate proximity distance 280 by direct or indirect measurement. The nature of the metrology tool 140 may vary depending on the particular measurement used to determine the value of the gate proximity distance 280. The gate proximity distance 280 may be estimated at various points in the process flow. For purposes of the following illustrations, the gate proximity distance 280 is measured following the recess etch used to define the recesses 260 in the semiconductor layer 210. However, the gate proximity distance 280 may also be measured after the spacer layer is deposited (e.g., estimated based on the layer thickness and the expected etch characteristics), after the spacer etch and prior to the recess etch, or after the formation of the stressed semiconductor material 290. Removal processes such as the spacer etch and recess etch have the potential to change the value of the gate proximity distance 280 by introducing variation in the width of the spacers 250. The particular measurement point selected may vary depending on the type of metrology resources available and the degree of variability introduced by the etch processes. In some embodiments, the metrology tool 140 may measure the characteristics of actual devices to determine the gate proximity distance 280, while in other embodiments, test structures having structures similar to the actual devices (i.e., without the underlying topology) may be used.

In the illustrated embodiment, the metrology tool 140 is a scatterometry tool that includes optical hardware, such as an ellipsometer or reflectometer, and a data processing unit loaded with a scatterometry software application for processing data collected by the optical hardware. For example, the optical hardware may include a model OP5140 or OP5240 with a spectroscopic ellipsometer offered by Therma-Wave, Inc. of Freemont Calif. The data processing unit may comprise a profile application server manufactured by Timbre Technologies, a subsidiary of Tokyo Electron Limited, Inc. of Tokyo, Japan and distributed by Therma-Wave, Inc. The metrology tool 140 may be external or, alternatively, the metrology tool 140 may be installed in an in-situ arrangement.

The controller 150 provides feedback to the deposition tool 120 and/or the etch tool 130 based on the gate proximity distance 280 measurements generated by the metrology tool 140. The controller 150 adjusts the operating recipe of the controlled tool 120, 130 to adjust the deposition and/or etching processes for subsequently processed wafers 110 to reduced variability in the gate proximity distance 280 from an established target value.

In the illustrated embodiment, the controller 150 and/or performance target monitor 160 may be implemented using one or more computers programmed with software to implement the functions described. However, as will be appreciated by those of ordinary skill in the art, a hardware controller designed to implement the particular functions may also be used. Moreover, the functions performed by the controller 150 or the performance target monitor 160, as described herein, may be performed by multiple devices distributed throughout a system. Additionally, the controller 150 or performance target monitor 160 may be stand-alone deices or they may be integrated into a tool, such as the deposition tool 120, etch tool 130, or the metrology tool 140, or they may be part of a system controlling operations in an integrated circuit manufacturing facility.

Portions of the detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The performance target monitor 160 adjusts the target values for gate proximity distance 280 used by the controllers 150 for controlling the operating recipes of the tools 120, 130. The performance target monitor 160 may access the metrology data collected regarding the performance of the tools 120, 130 and the overall processing line 100 to determine performance metrics such as speed, yield, power consumption, switching voltage, leakage current, etc., for the various lots of wafers and their associated devices. The performance target monitor 160 correlates the process metrology data and the target values to the manufacturing metrics to adjust the target values for gate proximity distance 280 used by the controller 150.

The performance target monitor 160 evaluates the manufacturing metric distributions and adjusts the process target values used by the controller 150 to control the operating recipe of the tools 120, 130 based on a predetermined strategy. Managers of the processing line 100 may determine manufacturing goals based on current business needs. For example, if inventory levels are low, a yield maximization strategy may be desired. If customer demand for high-speed devices is high, a speed maximization strategy may be desired. A combination strategy that maximizes both yield and speed may also be chosen. Other manufacturing metrics, such as power consumption may also be incorporated into the control strategy. Based on the strategy selected a target performance distribution for fabricated devices may be generated specifying the number of devices of particular grades that should be fabricated based on the forecasted needs. The desired grades may then be matched to target values for the gate proximity distance 280 to attempt to fabricate devices that meet the target performance distribution.

Based on the selected strategy, the performance target monitor 160 adjusts the target value for gate proximity distance 280 used by the controller 150. In general, the performance target monitor 160 will decrease the gate proximity target value if a speed maximization strategy is desired and increase the gate proximity target value if a yield maximization strategy is desired.

The performance target monitor 160 may adjust the gate proximity target values for different groupings of the tools 120, 130. For example, one set of tools 120, 130 may have gate proximity target values selected based on one maximization strategy, and another set of tools 120, 130 may use a different strategy. Controlling the tools 120, 130 in this manner allows the overall output of the manufacturing system to be controlled to meet customer demand for various device grades.

In general, the performance target monitor 160 provides gate proximity target values to the controller 150 for controlling the tools 120, 130. The performance target monitor 160 may determine the target gate proximity required to fabricate devices of a particular performance grade. In one embodiment, the performance target monitor 160 may act as a supervisory controller that provides process target values for the controller 150 to affect the desired performance distribution. In such a case, the controller 150, may determine operating recipe parameters of one or more of the tools 120, 130 to achieve the target gate proximity. The controller 150 may receive feedback from the metrology tool 140 of actual gate proximity to implement run-to-run feedback control of the tools 120, 130.

The performance target monitor 160 may adjust various tool process targets and/or operating recipe parameters to affect the resultant gate proximity. For example, the performance target monitor 160 may adjust the target thickness of the spacer layer formed by the deposition tool 120, and/or or the etch time of the etch tool 130 for etching the spacer layer or the recesses 260. The performance target monitor 160 may also adjust one or more parameters of a pre-treatment process (e.g., pre-clean and/or pre-bake) performed prior to the formation of the stressed material 290 to affect the resultant gate proximity.

In some embodiments, the performance target monitor 160 may employ control routines and directly manipulate operating recipe parameters for the controlled tool 120, 130. In this manner, the functionalities of the performance target monitor 160 and the controller 150 may be partially or fully combined into a single entity.

The frequency at which the performance target monitor 160 adjusts the gate proximity target values may vary. For example, the performance target monitor 160 may adjust the target values once per shift, once per day, once per week, etc. Managers of the processing line 100 may also use the manufacturing metric information collected by the performance target monitor 160 when making decisions regarding the maximization strategies.

In some embodiments, the performance target monitor 160 may also consider other metrology data indicative of performance in determining the target gate proximity. The CD of the gate electrode 220 is also a significant factor affecting expected device performance. The performance target monitor 160 may compensate for variations in CD by changing the gate proximity. For example, if the performance target monitor 160 is attempting to fabricate devices with a given performance level, the effects of CD and gate proximity may be combined. If the CD of an incoming wafer 110 is larger than the value required to achieve the target performance, the gate proximity may be reduced to attempt to compensate for the CD variation and increase device performance. Similarly, if the CD is smaller than the target CD, indicating a potential performance level higher than required to meet customer needs, the gate proximity may be increased to attempt to increase yield. In this manner, the CD and gate proximity measurements may be used in a run-to-run control technique that seeks to reduce variation in the expected device performance by manipulating gate proximity in view of incoming gate CD.

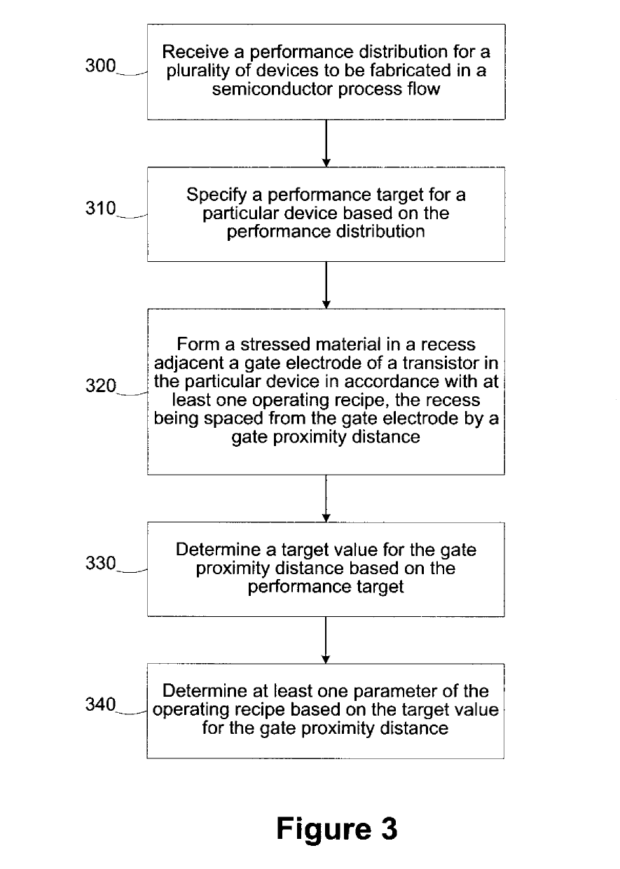

Turning now to FIG. 3, a simplified flow diagram of a method for controlling stressed layer gate proximity in accordance with another illustrative embodiment of the present subject matter is provided. In method block 300, a performance distribution for devices to be fabricated in a semiconductor process flow is received. In method block 310, a performance target for a particular device is specified based on the performance distribution. In method block 320, a stressed material is formed in a recess adjacent a gate electrode of a transistor in the particular device in accordance with at least one operating recipe. The recess is spaced from the gate electrode by a gate proximity distance. In method block 330, a target value for the gate proximity distance is determined based on the performance target. In method block 340, at least one parameter of the operating recipe is determined based on the target value for the gate proximity distance.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
receiving a performance distribution for a plurality of devices to be fabricated in a semiconductor process flow;
specifying a performance target for a particular device based on the performance distribution;
forming a stressed material in a recess adjacent a gate electrode of a transistor in the particular device in accordance with at least one operating recipe, the recess being spaced from the gate electrode by a gate proximity distance;
determining a target value for the gate proximity distance based on the performance target; and
determining at least one parameter of the operating recipe based on the target value for the gate proximity distance.

2. The method of claim 1, further comprising:
measuring the gate proximity distance of the particular device; and
adjusting the at least one parameter of the operating recipe based on a difference between the measured gate proximity distance and the target value for the gate proximity distance.

3. The method of claim 2, wherein measuring the gate proximity distance further comprises measuring the gate proximity distance using a scatterometry tool.

4. The method of claim 2, wherein forming the stressed layer comprises:
forming a dielectric spacer layer above the gate electrode;
etching the dielectric spacer layer to define sidewall spacers on at least sidewalls of the gate electrode;
forming recesses adjacent the gate electrode using the sidewall spacers as an etch mask; and
filling the recesses with the stressed material.

5. The method of claim 4, wherein measuring the gate proximity distance further comprises:
measuring a thickness of the dielectric spacer layer; and
estimating the gate proximity distance based on the measured thickness of the dielectric spacer layer.

6. The method of claim 4, wherein measuring the gate proximity distance further comprises:
measuring a width of the sidewall spacers; and
estimating the gate proximity distance based on the measured thickness of the sidewall spacers.

7. The method of claim 4, wherein measuring the gate proximity distance further comprises measuring the gate proximity distance after forming the recessed and prior to filling the recesses with the stressed material.

8. The method of claim 1, wherein forming the stressed layer comprises:
forming a dielectric spacer layer above the gate electrode;
etching the dielectric spacer layer to define sidewall spacers on at least sidewalls of the gate electrode;
forming recesses adjacent the gate electrode using the sidewall spacers as an etch mask; and
filling the recesses with the stressed material.

9. The method of claim 8, wherein determining the at least one parameter of the operating recipe further comprises determining at least one operating recipe parameter for forming the dielectric spacer layer to adjust a thickness of the spacer layer.

10. The method of claim 8, further comprising:
determining a process target value for at least one of the forming, etching, or filling based on the target value for the gate proximity distance; and
determining the at least one operating recipe parameter based on the process target value.

11. The method of claim 8, wherein determining the at least one parameter of the operating recipe further comprises determining at least one operating recipe parameter for forming the dielectric spacer layer to adjust a thickness of the spacer layer.

12. The method of claim 8, wherein determining the at least one parameter of the operating recipe further comprises determining at least one operating recipe parameter for etching the dielectric spacer layer to adjust a thickness of the sidewall spacers.

13. The method of claim 8, wherein determining the at least one parameter of the operating recipe further comprises determining at least one operating recipe parameter for forming the recesses to adjust the gate proximity distance.

14. The method of claim 8, further comprising performing at least one of a pre-treatment process prior to filling the recesses, and wherein determining the at least one parameter of the operating recipe further comprises determining at least one operating recipe parameter for the pre-treatment.

15. The method of claim 1, further comprising:
receiving a critical dimension measurement of the gate electrode; and
determining the target value for the gate proximity distance based on the performance target and the critical dimension measurement.

16. The method of claim 1, wherein the devices are fabricated in a plurality of tools arranged into groups, and the method further comprises specifying performance targets for each of the groups based on the performance distribution.

17. The method of claim 1, further comprising fabricating subsequent devices based on the operating recipe with the determined parameter.

18. A system, comprising:
a plurality of tools for fabricating a plurality of devices, wherein the tools are operable to form a stressed material in a recess adjacent a gate electrode of a transistor in a particular device in accordance with at least one operating recipe, the recess being spaced from the gate electrode by a gate proximity distance; and
a performance target monitor operable to receive a performance distribution for the devices to be fabricated in the tools, specify a performance target for the particular device based on the performance distribution, determine a target value for the gate proximity distance based on the performance target, wherein the tools are operable to fabricate the particular device based on the target value for the gate proximity distance.

19. The system of claim 18, wherein the performance target monitor is operable to determine a process target value for at least one of the tools, and the system further comprises a controller operable to receive the process target value and determine at least one operating recipe parameter for the at least one tool based on the process target value.

20. The system of claim 18, further comprising a controller operable to receive the target value for the gate proximity distance and determine at least one parameter of the operating recipe based on the target value for the gate proximity distance.

21. The system of claim 18, further comprising a metrology tool operable to measure the gate proximity distance and adjust at least one parameter of the operating recipe for fabricating subsequent devices based on a difference between the measured gate proximity distance and the target value for the gate proximity distance.

22. The system of claim 21, wherein the metrology tool comprises a scatterometry tool.
